(19) United States
(12) Patent Application Publication
(10) Pub. No.: US 2006/0098374 A1
(43) Pub. Date: May 11, 2006

(54) Method and apparatus for protecting wireless communication systems from ESD and surge

(76) Inventor: Tai Won Youn, Albuquerque, NM (US)

Correspondence Address: BLANK ROME LLP, 600 NEW HAMPSHIRE AVENUE, N.W., WASHINGTON, DC, 20037, US

(21) Appl. No.: 10/975,339

(22) Filed: Oct. 29, 2004

(51) Int. Cl. H02H 9/06

(52) U.S. Cl. 361/119

(57) ABSTRACT

A method and apparatus for protecting wireless communication systems from ESD/surge is disclosed. A capacitor is connected in series with a shunt resonating circuit and inserted between a transceiver and outside antenna of the wireless communication system. The shunt resonating circuit may include a shunt inductor in parallel with a shunt capacitor. A resistor may be connected in series between the shunt inductor and the shunt capacitor. The shunt resonating circuit acts like an open circuit with high impedance, and also acts like a short circuit with low impedance at operating frequency bands of the transceiver. The capacitor provides additional protection for the transceiver against low frequency spectrum by acting like a high pass filter.

### FIELD OF THE INVENTION

The present invention is generally related to data communications and, more particularly, is related to a method and apparatus for protecting a wireless communication system from ESD and surge voltage.

### BACKGROUND OF THE INVENTION

Data communication lines and equipment are vulnerable to electrical transients. One such transient is a close lightening strike, which can affect nearby data lines through induction. Industrial transients caused by switching and commuting of electrical motors are also significant disturbances. The operation of such devices can cause abrupt shifts in the nearby data line to equalize the ground potential.

Electrostatic discharge (ESD) is another form of an electrical surge that can be detrimental to data communication lines. ESD is caused by two non-conducting materials rubbing together, causing electrons to transfer from one material to the other. Once the material comes in contact with another object of lower electrical potential, a discharge occurs.

Lightening strikes are the most severe cases of ESD. Although the event is brief, the amount of energy that is carried can be great. A typical transient event can last from a few nanoseconds to several milliseconds, carrying several thousand volts and at least a few hundred amperes of current which can cause burnt line cards, lockups, loss of memory, problems in retrieving data, and garbling.

To protect equipment from incoming surges through the data line, the user must first determine the electrical specifications of the equipment being protected. Twisted pair applications are the most common form of wiring in data communications. Twisted pair applications consist of two identical wires wrapped together in a double helix. Both wires in the pair have the same impedance to ground, making the pair a balanced medium. That characteristic helps to lower the wiring's susceptibility to noise from neighboring cables or external sources.

Wireless communication systems, such as electronic identification devices, also experience ESD and surge voltage. Electronic identification devices, such as radio frequency identification devices (RFID), are typically used for inventory tracking. As large numbers of objects are moved in inventory, product manufacturing, and merchandising operations, there is a continuous challenge to accurately monitor the location and flow of objects. One way of tracking objects is with an electronic identification system.

Electronic identification systems utilize an RF transponder device affixed to an object to be monitored, in which a controller or interrogator unit transmits an interrogation signal to the device. The device receives the signal, waits and transmits a responsive signal. The interrogation signal and a responsive signal are typically radio frequency (RF) signals produced by an RF transmitter circuit. Since RF signals can be transmitted over greater distances than magnetic fields for example, RF-based transponder devices tend to be more suitable for applications requiring tracking of a tag device that may not be in close proximity to an interrogator unit, such as that in wireless communications. As a result, responsive signals are frequently generated. In the case of a battery-operated device, the life of the battery is severely diminished due to the frequent unintentional wake-ups of the device.

The conventional approach to achieve higher device ESD protection is to incorporate on-chip ESD protection networks. Some communication applications require that the transceivers operate with antennas installed outdoors. The outdoor antenna is subject to lightening, and ESD and could lead to transceiver damage when the transceiver does not have a proper protecting circuit. ESD voltage could reach as high as 15 KV with a 0.3 nanoseconds rise time. The surge voltage could be as high as 6 KV with a pulse-width of 50 microseconds. Spectrum analysis shows that ESD signals have a spectrum in the neighborhood between DC and 1.3 GHz, while the surge signals are in the neighborhood between DC and 160 MHz. Thus, without proper protection against surge voltage and ESD, degradation of the performance of the RF circuits is most prevalent.

Thus, there is a need in the art to address the aforementioned deficiencies and inadequacies associated with protecting wireless communication systems from ESD and surge damage.

### SUMMARY OF THE INVENTION

Embodiments of the present invention provide an apparatus and method for protecting a wireless communication system from ESD and surge damage by positioning an ESD/surge protection circuit between the transceiver and the antenna of the wireless communication system.

Briefly described, a preferred embodiment of the apparatus can be implemented as follows. In the preferred embodiment, an ESD/surge protection circuit includes a series capacitor and a shunt resonating circuit inserted between the transceiver and the antenna of the wireless communication system. The shunt resonating circuit includes a shunt inductor in parallel with a shunt capacitor, with a shunt resistor in series between the shunt inductor and the shunt capacitor.

Embodiments of the present invention can also be viewed as providing methods for incorporating the ESD/surge protection circuit in a wireless communication system. The claimed method includes positioning a shunt resonating circuit between the transceiver and the antenna of the wireless communication system so that the circuit acts like an open circuit with a high impedance at the operating frequencies of the transceiver. Also, in the preferred method, the shunt resonating circuit acts like a short circuit with low impedance outside the operating frequency band of the transceiver.

Other systems, methods, features and advantages of the present invention will become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention.

FIG. 1 is a schematic block diagram of a wireless communication system with the ESD/surge protection circuit inserted between the transceiver and the antenna.

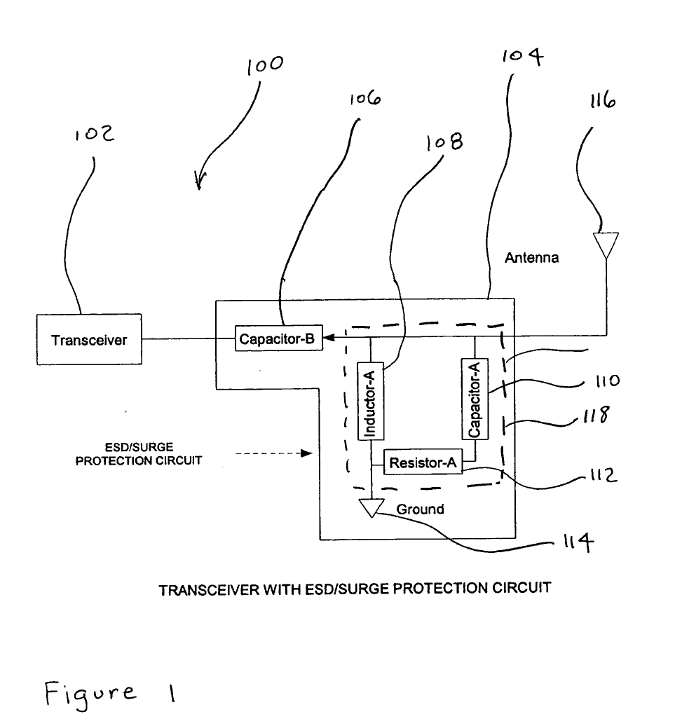

### DETAILED DESCRIPTION OF THE PREFERRED EMBODIMENT

Wireless communication spectrum concentrations enable the ESD/surge protection circuit 104 to be used for transceivers with an operating range of around 900 MHz. The ESD/surge protection circuit 104 includes a capacitor 106 in series with a shunt resonating circuit 118 positioned between the transceiver 102 and the antenna 116 of the wireless communication system 100. The shunt resonating circuit 118 includes a shunt inductor 108 in parallel with a shunt capacitor 110. A resistor 112 is connected in series between the shunt inductor 108 and the shunt capacitor 110. The shunt resonating circuit 118 may then be connected to a ground 114. In the preferred embodiment, the shunt inductor 108 may have a value of 8.0 nh with Q>100 at 1000 MHZ, the shunt capacitor 110 may have a value of 3.3 pf with Q>600 at 1000 MHZ, and the resistor 112 may have a value of no more than 0.5 ohms. The value of the resistor 112 is the effective resistance reflecting the Q of the shunt inductor 108.

The shunt resonating circuit 118 acts like an open circuit with high impedance (i.e., greater than 500 ohms) at the operating frequency of the transceiver 102, (approximately 900 MHz). The shunt resonating circuit 118 acts like a short circuit with low impedance outside the operating frequency band of the transceiver 102. The center frequency of the shunt resonating circuit 118 is determined by the values of the shunt inductor 108, and the shunt capacitor 110. The bandwidth is determined by the resistor 112 that includes the effective resistance representing the limited Q of resonator components 108 and 110.

The shunt inductor 108 can momentarily discharge a high current (>3000 amps) incurred by a surge pulse with an 80 microsecond pulse, and prevent high steady state voltage buildup at the outdoor antenna 116. The capacitor 106 can provide additional protection for the transceiver 102 against low frequency spectrum by acting like a high pass filter. The shunt capacitor 110 is designed to include a high breakdown voltage.

It should be emphasized that the above-described embodiments of the present invention, particularly, any preferred embodiments, are merely possible examples of implementations, merely set forth for a clear understanding of the principles of the invention. Many variations and modifications may be made to the above described embodiments of the invention without departing substantially from the spirit and principles of the invention. All such modifications and variations are intended to be included herein within the scope of this disclosure and the present invention and protected by the following claims.

What is claimed is:

1. An ESD/surge protection circuit for a wireless communication system, comprising:
a capacitor connected to a transceiver; and
a shunt resonating circuit connected in series with the capacitor.

2. The protection circuit according to claim 1, wherein the shunt resonating circuit comprises:
a shunt inductor;
a shunt capacitor in parallel with the shunt inductor; and
a resistor connected in series between the shunt inductor and the shunt capacitor.

3. The protection circuit according to claim 1, wherein the shunt resonating circuit acts like an open circuit with a high impedance at operating frequencies of the transceiver.

4. The protection circuit according to claim 3, wherein the high impedance is greater than 500 ohms.

5. The protection circuit according to claim 1, wherein the shunt resonating circuit acts like a short circuit with low impedance outside an operating frequency band of the transceiver.

6. The protection circuit according to claim 3, wherein the operating frequency of the transceiver is approximately 900 MHz.

7. The protection circuit according to claim 2, wherein the shunt inductor momentarily discharges a high current, greater than 3000, incurred by a surge pulse with an 80 μs pulse.

8. The protection circuit according to claim 2, wherein the shunt capacitor has a high breakdown voltage.

9. A method for protecting a wireless communication system from ESD and surge, comprising the step of positioning an ESD/surge protection circuit between a transceiver and an antenna of the wireless communication system.

10. The method of claim 9, further comprising the step of providing a capacitor in series with a shunt resonating circuit to comprise the ESD/surge protection circuit.

11. The method of claim 10, further comprising the steps of:
connecting a shunt inductor to the capacitor;
connecting a shunt capacitor in parallel with a shunt inductor; and
connecting a resistor in series between the shunt inductor and the shunt capacitor to comprise the shunt resonating circuit.

12. The method of claim 10, further comprising the step of enabling the shunt resonating circuit to operate as an open circuit with a high impedance at operating frequencies of the transceiver.

13. The method of claim 10, further comprising the step of enabling the shunt resonating circuit to operate as a short circuit with low impedance outside an operating frequency band of the transceiver.

14. The method of claim 11, further comprising the steps of determining a center frequency and bandwidth of the shunt resonating circuit using the shunt inductor, the shunt capacitor and the resistor.

15. An ESD/Surge protection circuit that is positioned between an antenna and a wireless communication system.

16. The protection circuit of claim 15, wherein lumped parameter components are used.

17. The protection circuit according to claim 2, wherein the shunt resonating circuit further comprises:
said shunt inductor with a value of 8.0 nh with Q>100 at 1000 MHZ;
said shunt capacitor with a value of 3.3 pf with Q>600 at 1000 MHA; and
said resistor with a value no more than 0.5 ohms.

18. The method of claim 11, further comprising the steps of:
using said shunt inductor with a value of 8.0 nh with Q>100 at 1000 MHZ;
using said shunt capacitor with a value of 3.3 pf with Q>600 at 1000 MHZ; and
using said resistor with a valve no more than 0.5 ohms.
